(19) United States
(12) Patent Application Publication
(10) Pub. No.: US 2008/0024939 A1
(43) Pub. Date: Jan. 31, 2008

(54) COMMUNICATION SYSTEM FOR HAZARDOUS ENVIRONMENTS

(75) Inventor: Ian COOPER, Swadlincote (GB)

Correspondence Address: GARDNER GROFF GREENWALD & VILLANUEVA. PC, 2018 POWERS FERRY ROAD, SUITE 800, ATLANTA, GA, 30339, US

(73) Assignee: CONTROLLED SYSTEMS LTD, Swadlincote (GB)

(21) Appl. No.: 11/779,747

(22) Filed: Jul. 18, 2007

(30) Foreign Application Priority Data
Jul. 27, 2006 (GB) 0614936.3

(51) Int. Cl. H02H 7/20; G06F 1/00

(52) U.S. Cl. 361/1; 713/300

(57) ABSTRACT

The present invention provides for an Ethernet, or similar, communication system safety device for hazardous environments arranged for coupling to an apparatus within a hazardous environment in an Intrinsically Safe manner, including first input means arranged for receiving data signals; first output means arranged to transmit data signals; and an energy limiting means having at least one capacitor, and generally at least two capacitors, arranged to block a DC component of data signals received in the safety device, the energy limiting means being coupled at a first end to the first input means and at a second end to the first output means and arranged to limit the energy of data signals received in the safety device prior to transmission.

### CROSS-REFERENCE TO RELATED APPLICATION

This application claims priority benefit to U.K. Patent Application Serial No. 0614936.3, filed Jul. 27, 2006, which application is incorporated herein by reference in its entirety for all purposes.

### TECHNICAL FIELD

The present invention relates to a communication system and particularly to a communication system for hazardous environments.

### BACKGROUND OF THE INVENTION

Ethernet is a well known example of a communication system for use in office environments for networking Information Technology (IT) systems involving personal computers (PCs) and peripherals. It is now being widely introduced into factories and other industrial locations as the need for interchange of process data and information increases along with the introduction of more complex items of machinery and plant. In industries operating in non-hazardous conditions, essentially the same techniques and equipment can be used as in office environments, although such equipment is often “toughened” for industrial use, thereby allowing it to operate reliably in extremes of environmental conditions. Thus the operational temperature range is typically extended from a 0 to 40° C. range of operation (as in an office environment) to a −40 to +70° C. range of operation in industry. An industrial Ethernet system also has improved protection against shock, vibration, electrostatic discharges (ESD) and immunity to transients and surges which are more likely to be found in industrial than office environments.

Areas are considered hazardous where there is an atmosphere containing flammable or combustible materials (e.g. fuels, flammable gases, explosive vapours, combustible dusts, etc), and where the atmosphere has the potential to ignite. To extend an Ethernet system into such hazardous areas, it has to be rendered non-incendive or Intrinsically Safe to the relevant standards (which will be known to the PATENT person skilled in the art). This means that the Ethernet system must not produce a spark that has sufficient energy or heat to cause an ignition of gases or dusts both during normal operation and when in a fault condition. However, there are problems in rendering an Ethernet system non-incendive or Intrinsically Safe because there is a conflict between the performance requirements of the Ethernet system and the energy-limitation required to render it non-incendive or Intrinsically Safe.

So far, Ethernet systems have found limited applications in the least onerous hazardous areas, known as Zone 2 or Division 2 in the standardised classification adopted by the relevant regulatory bodies. Normal industrial Ethernet devices can be used in Zone 2 environments provided they are safe (i.e. non-incendive) in normal operation. No special techniques are necessary to render these devices non-incendive, but they need to be examined and may be certified by a notified body as suitable for such use. A limitation of these known devices for Zone 2 environments is that it is not permitted to disconnect the Ethernet system connections when a gas is potentially present: a practice known as “live-working”. In order for live-working to be permitted in a Zone 2 environment, or for any use in more onerous hazardous environments, such as Zone 1 or Zone 0, the Ethernet system and its associated devices (e.g. ports, etc.) must be protected to ensure that any sparks that may be generated when live-working takes place are below the levels recognised as causing ignition in relevant safety standards. Thus, in practice, such systems and devices must be certified as being Intrinsically Safe.

A usual technique for rendering systems/devices Intrinsically Safe so that the electrical energy used/generated does not exceed predetermined energy levels deemed sufficient to produce a spark and to permit live working, is to incorporate energy-limiting barrier-type circuits based on series resistance and voltage-clamping Zener diodes into the system/device. However, such circuits can distort a signal transmitted via the Ethernet system which has a detrimental effect on the signal quality over the system and so are unsuitable due both to the relatively high series resistance required and the capacitance of the Zener diodes causing a loading impedance effect on the high frequency Ethernet signals.

UK Patent Application No. GB 2 406 726 discloses a safety device for use with a communication bus and proposed to overcome the disadvantages described above. The device is arranged to monitor the communication system and, upon detection of a fault or cable disconnection, to isolate the hazardous signals before they can cause an incendive spark that may cause and ignition of gases or dusts.

However, this system relies on the cable being disconnected ‘cleanly’. A cable damaged in a particular way could still result in an incendive spark being produced that would render the system unsafe.

### SUMMARY OF THE INVENTION

The present invention seeks to provide for a communication system for hazardous environments having advantages over known such systems.

According to an aspect of the present invention, there is provided an Ethernet communication system safety device for hazardous environments arranged for coupling to an apparatus within an hazardous environment in an Intrinsically Safe manner, comprising first input means arranged for receiving data signals; first output means arranged to transmit data signals; and an energy limiting means comprising at least one capacitor arranged to block a DC component of data signals received in said safety device, said energy limiting means being coupled at a first end to said first input means and at a second end to said first output means and arranged to limit the energy of data signals received in said safety device prior to transmission.

An advantage of the present invention is that, by limiting the energy of the data signals transmitted to below a pre-determined (i.e. Intrinsically Safe) level, the system can still be operated under live-working conditions, since the energy of the data signals is insufficient to produce a spark. Further, the capacitors block the higher power DC component but allow the small high frequency component of the data signal to pass because they offer only a low impedance path to the data signal. Thus, the potential energy level of the signal under normal and fault conditions is greatly reduced because the DC component is removed, but the small data signal carried by the high frequency component of the signal is unaffected. This makes for an easier assessment against Intrinsic Safety.

Generally the energy limiting means will comprise at least two capacitors.

Preferably the device further comprises a second output means arranged for transmitting data signals and a second input means arranged for receiving signals, and wherein said second output means is coupled to a first end of said energy limiting means and said second input means is coupled to said second end of said energy limiting means.

In particular, said device further comprises a filter module coupled between said first input means and said first end of said energy limiting means.

Also, said device further comprises a filter module coupled between said first input means and said first end of said energy limiting means and also between said second output means and said first end of said energy limiting means.

Conveniently, said filter module is arranged to provide at least one of impedance matching, signal shaping and conditioning, high-voltage isolation, and common-mode noise reduction.

Further, said filter module comprises a magnetic element.

If required, said magnetic element comprises a transformer module.

In particular, said transformer module is configured in a common-mode configuration and incorporates common-mode rejection filter chokes (CMF).

Also, said second input means is arranged for coupling to a first transmission path of a communication bus and said first output means is arranged for coupling to a second transmission path of said communication bus.

Advantageously, said safety device further comprises power input terminals for receiving a power supply and where said power input terminals are coupled to power output terminals arranged for connection to a communication bus.

Preferably, said power output terminals comprise two terminals, with a first of said power output terminals arranged for connection to a third transmission path of said communication bus and a second of said power output terminals arranged for connection to a fourth transmission path of said communication bus.

Conveniently, said device is configured such that, when connected to said communication bus, said third and fourth transmission paths are coupled to a ground terminal of said safety device via a resistor and capacitor in series.

If required, said safety device is arranged to supply power through said communication bus.

In particular, said system is arranged to supply power at a voltage of 12V.

Also, said device is arranged to transmit/receive signals differentially.

Advantageously, said device is compatible with an RJ45 Ethernet connector.

According to another aspect of the present invention, there is provided a communication system for use in a hazardous environment comprising: at least two apparatus arranged to transmit and receive data signals; a communication bus arranged to communicate data signals between said at least two apparatus; and at least two safety devices as described above, each coupled to a corresponding one of said at least two apparatus and further coupled to said communication bus.

Preferably, said communication bus comprises first, second, third and fourth transmission paths, and said first, second, third and fourth transmission paths comprise twisted pair cable.

Conveniently, said data signals are communicated differentially.

Further, said communication bus comprises one of an unshielded cable or a shielded cable.

### BRIEF DESCRIPTION OF THE DRAWINGS

The present invention is described further hereinafter, by way of example only, with reference to the accompanying drawings in which:

FIG. 1 illustrates a schematic block diagram of a communication system for communicating data between non-intrinsically safe devices located in a non-hazardous area, between intrinsically safe apparatus located in a hazardous area, and between non-intrinsically safe devices located in a non-hazardous area and intrinsically safe apparatus located in a hazardous area;

FIG. 2 illustrates a schematic diagram of a communication bus for communicating between intrinsically safe apparatus of FIG. 1; and

FIG. 3 illustrates a communication port for connection between said intrinsically safe apparatus and said communication bus.

### DETAILED DESCRIPTION OF EXAMPLE EMBODIMENTS

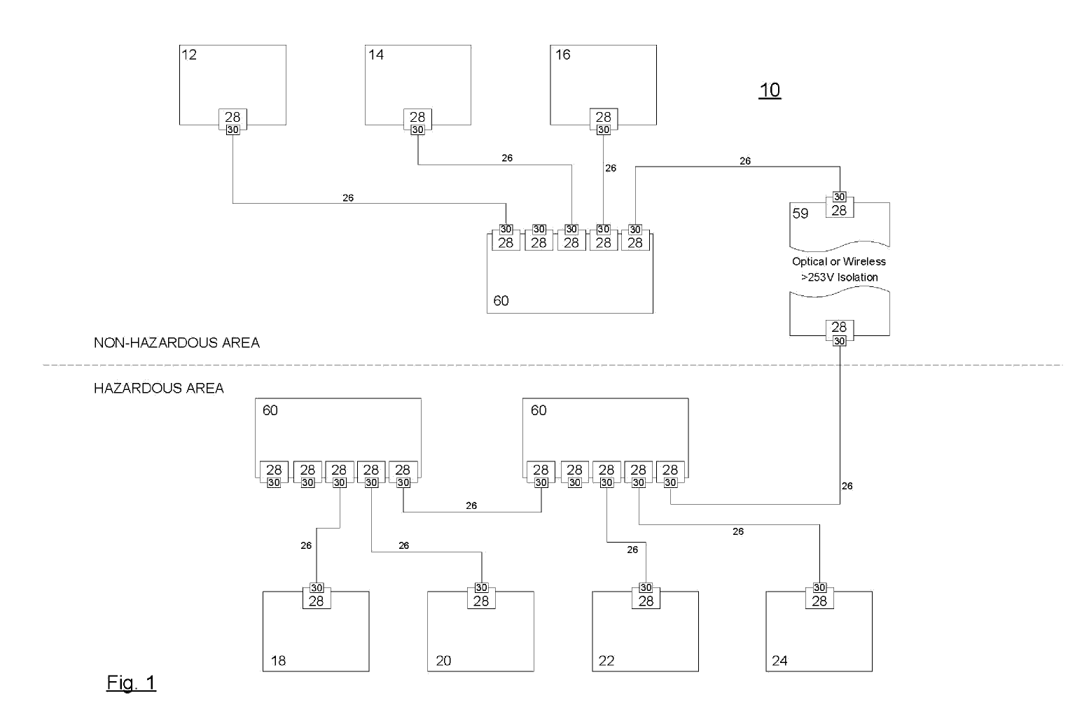

As mentioned, FIG. 1 illustrates a communication system 10 which includes a plurality of (Non-Intrinsically Safe) devices 12, 14, 16 (for example, a personal computer, server, HMI Interface, etc.) and a plurality of Intrinsically Safe (I.S.) apparatus 18, 20, 22, 24 (for example, Remote I/O, Process Controller, etc.). Each of the plurality of devices 12, 14, 16 and the plurality of I.S. apparatus 18, 20, 22, 24 are communicatively coupled to each other by way of communication buses 26. The apparatus and devices are typically interconnected at a switching hub 60, which manages crossing over of transmit and receive pairs as required. In the present embodiment, the function of the plurality of devices 12, 14, 16 and the plurality If I.S. apparatus 18, 20, 22, 24 is unimportant. However, for illustrative purposes, the plurality of I.S. apparatus 18, 20, 22, 24 may perform detection, actuation, etc. and the plurality of devices 12, 14, 16 may be arranged to control, monitor, etc. the plurality of I.S. apparatus 18, 20, 22, 24.

A communication port 28 is coupled to each of the plurality of devices 12, 14, 16 and to each of the plurality of I.S. apparatus 18, 20, 22, 24. Further, a connector 30 is provided at each end of the communication bus 26 and each connector 30 is arranged to cooperate with a corresponding communication port 28 coupled to the plurality of devices 12, 14, 16, the plurality of I.S. apparatus 18, 20, 22, 24 and the plurality of switching hubs 60.

As can be seen in FIG. 1, the plurality of devices 12, 14, 16 are located in a Non-Hazardous environment, but the plurality of I.S. apparatus 18, 20, 22, 24 are located in a hazardous environment. The connection between them can be made with an optically isolated or wireless (RF) interface 59 to provide the necessary >253V isolation barrier between Non-Hazardous and Hazardous Area equipment.

In the present embodiment, the communication bus 26 is Ethernet based, but may be any suitable local area network (LAN) or wide area network (WAN). In particular, the Ethernet physical medium is a 10/100 base T network (as defined in The Institute of Electrical and Electronics Engineers (IEEE) standard 802.3). However, the Ethernet network may also be a 1000 base T network or other network with similar physical properties.

The physical layer for a 10/100 base T network is a cable employing twisted copper pairs. A standard cable has eight separate wires grouped as four twisted pairs, with one pair being for data transmission (TX) and another pair being for data receiving (RX). The remaining two pairs may be unused and are usually terminated at each end in the communication port but, in a particular arrangement, may be used to supply power to equipment in accordance with the IEEE 802.3af “Power over Ethernet” (PoE) standard. This PoE arrangement will be described in more detail later.

The arrangement of one pair of wires being for data transmission and another pair being for data receiving allows for full-duplex data transmission over the Ethernet cable.

The cable may comprise either an unshielded twisted pair, or a shielded variant for use where the likelihood of noise interference is high. Of course, any other suitable medium may be used as said cable.

The use of twisted pair cable is particularly convenient as it allows the communication system 10 to transmit and receive data differentially. Differential signalling is advantageous as it offers increased immunity to noise and crosstalk.

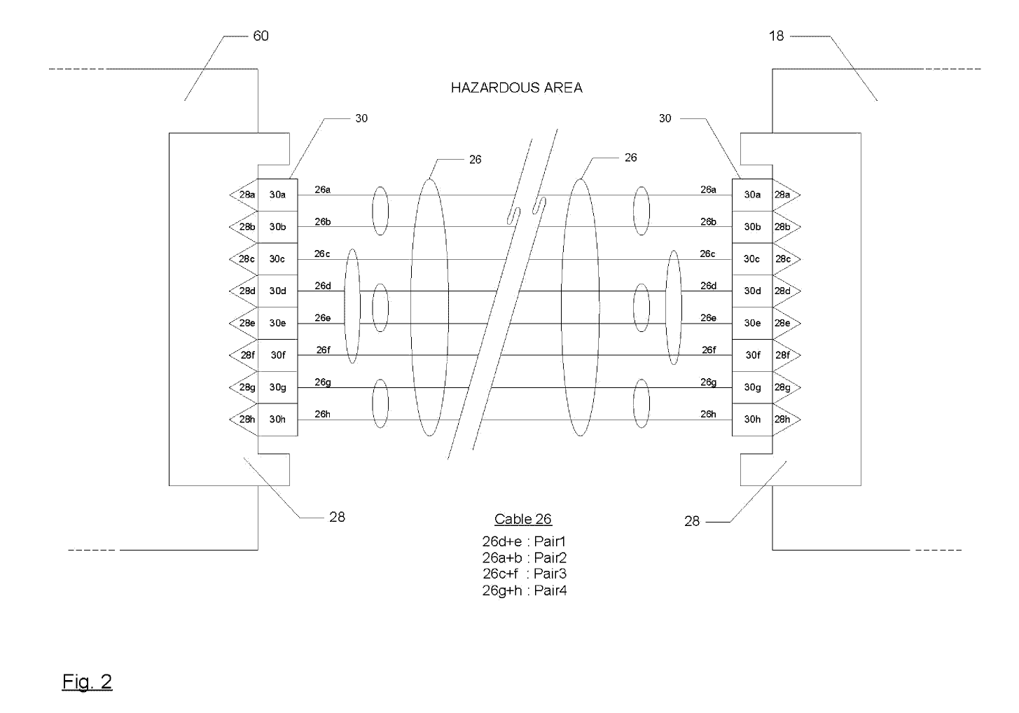

FIG. 2 illustrates in more detail the switching hub 60, the I.S. apparatus 18 (both located in a hazardous environment) and the communication bus 26 therebetween.

The communication port 28 of the switching hub 60 and the communication port 28 of the I.S. apparatus 18 each comprise eight individual communication ports 28a-28h which are arranged to communicatively couple with corresponding individual connectors 30a-30h of connectors 30 located at opposite ends of the communication bus 26. As described above, the communication bus 26 comprises an eight-wire cable. In the present case each individual cable 26a-26h of the communication bus 26 is provided at either end thereof with a corresponding individual connector 30a-30h, e.g. individual cable 26a has a corresponding individual connector 30a at each end thereof, individual cable 26b has a corresponding individual connector 30b at each end thereof, etc.

In the present embodiment, communication ports 28 and connectors 30 are RJ-45 Ethernet compatible, but any suitable connector interface may be used as an alternative.

It should be noted that in the present embodiment, individual connectors 30a-30h are male-type connectors and individual communication ports 28a-28h are female-type. Of course, in alternative arrangements the individual connectors 30a-30h may be female-type connectors and individual communication ports 28a-28h may be of the male-type.

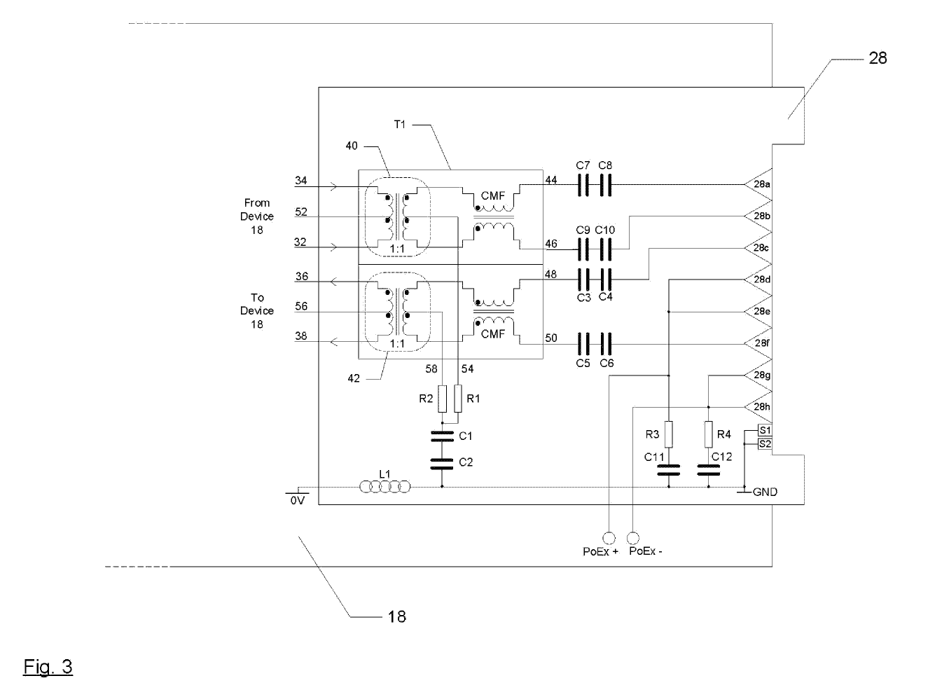

FIG. 3 illustrates a semi-schematic diagram of the communication port 28 of Intrinsically Safe apparatus 18.

As illustrated, the communication port 28 is provided with input means 32, 34 for receiving a differential data signal from I.S. apparatus 18. The communication port 28 is also provided with output means 36, 38 for communicating a differential data signal (received by the communication port 28 via the communication bus (not shown)) to I.S. apparatus 18.

Input means 32, 34 and output means 36, 38 are coupled to a transformer module T1 which comprises a first transformer 40 (illustrated within dotted line) and a second transformer 42 (illustrated within dotted line). In particular, input means 32, 34 are coupled to the first transformer 40 and the output means 36, 38 are coupled to the second transformer 42.

The first transformer 40 is coupled to transmission signal lines 44, 46 and the second transformer 42 is coupled to reception signal lines 48, 50.

In the present embodiment, the transformer module T1 is configured in a common-mode arrangement. Thus, the first transformer 40 is provided with first and second common-mode (CM) terminals 52, 54, where first CM terminal 52 is coupled to I.S. apparatus 18, and second CM terminal is coupled to a ground terminal GND via terminating resistor R1 coupled in series with capacitors C1, C2 (typically 1 nF). Similarly, second transformer 42 is provided with third and fourth CM terminals 56, 58, where third CM terminal 56 is coupled to I.S. apparatus 18, and second CM terminal is coupled to said ground terminal GND via terminating resistor R2 coupled in series with capacitors C1, C2.

As illustrated in FIG. 3, the ground terminal GND is coupled via series inductance L1 to the apparatus supply common terminal having a voltage of 0V. Inductor L1 is, however, an optional feature which may not be required in other arrangements.

Transmission signal line 44 is coupled to individual communication port 28a via series “blocking” capacitors C7, C8, whilst transmission signal line 46 is coupled to individual communication port 28b via series “blocking” capacitors C9, C10.

Receiver signal line 48 is coupled to individual communication port 28c via series “blocking” capacitors C3, C4, whilst receiver signal line 50 is coupled to individual communication port 28f via series “blocking” capacitors C5, C6. However, in an alternative arrangement, connections to individual communication port 28a may optionally be transposed with that of individual communication port 28c and those of individual communication port 28b with individual communication port 28f where a ‘cross-over’ connection is required.

The “blocking” capacitors C3-C10 typically have values of 100 nF. These “blocking” capacitors C3-C10 serve to block certain parameters (e.g. a DC component), but allow the small high frequency Ethernet signals to pass through unimpeded as these, being around 10 MHz to 30 MHz, are presented only a low impedance path (less than 1Ω)) by the “blocking” capacitors C3-C 10.

“Blocking” capacitors C3-C10 still allow the 10/100 base T Ethernet network to operate correctly at both 10 Mbps and 100 Mbps, but also render the communication port 28 Intrinsically Safe, since by allowing only the small high frequency Ethernet signal to pass, only a very small amount of energy can pass along the communication bus through the aforementioned hazardous environment. Thus, “blocking” capacitors C3-C10 effectively isolate the individual communication ports 28a, 28b, 28c, 28f from the transformer module T1 and the rest of the I.S. apparatus circuitry.

The “blocking” capacitors C1-C10 and C11-C12 are typically 1000 VDC rated MLC chip or equivalent high reliability solid dielectric (e.g. ceramic) capacitors.

Also illustrated in FIG. 3 are shield terminals S1, S2 which are coupled to said ground terminal GND of the communication port 28. These shield terminals S1, S2 are arranged to couple with shielding portions of a shielded type communication bus and serve to “ground” the shielding portions to prevent external interference from affecting data signals transmitted via the communication bus.

As mentioned previously, two pairs of the four twisted pair cables of the communication bus are used for transmitting/receiving data, and the other two pairs may be used to supply power under the Power Over Ethernet (PoE) standard.

The present invention also proposes a modification of the PoE standard: the modification, which shall be further referred to as PoEx, where the x signifies its hazardous area association. Standard PoE cannot be used in hazardous areas due to the high levels of voltage and power called for in the IEEE 802.3af standard (i.e. 13 Watts at 48 Volts). Therefore, the present invention proposes a lower voltage of 12V nominal with reduced power levels to meet Intrinsic Safety requirements.

FIG. 3 illustrates PoEx terminals PoEx+, PoEx− arranged to receive the modified 12V Intrinsically Safe power supply from an Ethernet switching hub 60 (Power Sourcing Equipment—PSE). PoEx terminal PoEx+ is coupled to those individual communication ports (28d, 28e) of the communication port 28 which are arranged for connection with one of the unused pairs of the communication bus and the other PoEx terminal PoEx− is coupled to those individual communication ports (28g, 28h) of the communication port 28 which are arranged for connection with the other of the unused pairs of the communication bus. Thus, the modified 12V power supply is distributed via the spare pairs of the communication bus to any device connected thereto (known as powered devices eg: I.S. apparatus 18).

FIG. 3 also illustrates that individual communication ports 28d, 28e (first “unused-pair” port) are coupled to one another and, in addition to being coupled to PoEx terminal PoEx+, are also coupled via resistor R3 and capacitor C11, in series, to the ground terminal GND. Similarly, individual communication ports 28g, 28h (second “unused-pair” port) are coupled to one another and, in addition to being coupled to PoEx terminal PoEx−, are also coupled via resistor R4 and capacitor C12, in series, to the ground terminal GND. Such an arrangement terminates the unused pairs without adding any unnecessary DC loading to the 12 VDC PoEx supply when connected, effectively “zero power termination”.

The above description relates to an embodiment in which a switching hub 60, located in a hazardous environment, is arranged for communication via a communication bus with an I.S. apparatus 18 also located in a hazardous environment. However, in an alternative arrangement, both the switching hub 60 and I.S. apparatus 18 may be located in non-hazardous environments and it is merely the communication bus connecting the two which passes through a hazardous environment. It is clear the present invention is also applicable to such a situation since signals passing through the communication bus in the hazardous environment must be below a certain energy level in order to avoid producing a spark in normal operation and also when in a fault condition.

Additional safety measures can be incorporated into the present invention to further enhance the described system. Such additional measures may comprise “encapsulating” the communication ports 28 and I.S. apparatus 18 in an enclosure which serves to prevent an explosive atmosphere from entering the enclosure. Thus, a spark within the enclosure will not ignite the external explosive atmosphere. This allows higher power levels to exist inside the apparatus than would otherwise be possible allowing for more powerful applications to be realised.

By arranging the apparatus to have its low voltage internal supply rail (typically 5V, 3.3 Volt or lower) clamped at a low level by Zener diodes, Crowbar circuitry or similar, the signal outputs derived from these power rails are also guaranteed to be at a low level (and nominally 1-2V) helping the Intrinsic Safety assessment.

What is claimed is:

1. An Ethernet communication system safety device for hazardous environments arranged for coupling to an apparatus within a hazardous environment in an Intrinsically Safe manner, comprising first input means arranged for receiving data signals; first output means arranged to transmit data signals; and an energy limiting means comprising at least one capacitor arranged to block a DC component of data signals received in said safety device, said energy limiting means being coupled at a first end to said first input means and at a second end to said first output means and arranged to limit the energy of data signals received in said safety device prior to transmission.

2. A device according to claim 1, further comprising a second output means arranged for transmitting data signals and a second input means arranged for receiving signals, and wherein said second output means is coupled to said first end of said energy limiting means and said second input means is coupled to said second end of said energy limiting means.

3. A device according to claim 1, further comprising a filter module coupled between said first input means and said first end of said energy limiting means.

4. A device according to claim 2, further comprising a filter module coupled between said first input means and said first end of said energy limiting means and also between said second output means and said first end of said energy limiting means.

5. A device according to claim 3, wherein said filter module is arranged to provide at least one of impedance matching, signal shaping and conditioning, high-voltage isolation, and common-mode noise reduction.

6. A device according to claim 3, wherein said filter module comprises a magnetic element.

7. A device according to claim 6, wherein said magnetic element comprises a transformer module.

8. A device according to claim 7, wherein said transformer module is configured in a common-mode configuration and incorporates common-mode rejection filter chokes.

9. A device according to claim 2, wherein said second input means is arranged for coupling to a first transmission path of a communication bus and said first output means is arranged for coupling to a second transmission path of said communication bus.

10. A device according claim 9, wherein said safety device further comprises power input terminals for receiving a power supply and where said power input terminals are coupled to power output terminals arranged for connection to a communication bus.

11. A device according to claim 10, wherein said power output terminals comprise two terminals, with a first of said power output terminals arranged for connection to a third transmission path of said communication bus and a second of said power output terminals arranged for connection to a fourth transmission path of said communication bus.

12. A device according to claim 11, wherein said device is configured such that, when connected to said communication bus, said third and fourth transmission paths are coupled to a ground terminal of said safety device via a terminating resistor and capacitor in series.

13. A device according to claim 10, wherein said safety device is arranged to supply power through said communication bus (PoEx).

14. A device according to claim 13, wherein said system is arranged to supply power at a voltage of 12V.

15. A device according to claim 2, wherein said device is arranged to transmit/receive signals differentially.

16. A device according to claim 1, wherein said device is compatible with an RJ45 Ethernet connector.

17. A communication system for use in a hazardous environment comprising: at least two apparatus arranged to transmit and receive data signals; a communication bus arranged to communicate data signals between said at least two apparatus;
and at least two safety devices according to any one or more of the preceding claims, each coupled to a corresponding one of said at least two apparatus and further coupled to said communication bus.

18. A system according to claim 17, wherein said communication bus comprises first, second, third and fourth transmission paths, and said first, second, third and fourth transmission paths comprises twisted pair cable.

19. A system according to claim 18, wherein said data signals are communicated differentially.

20. A system according to claim 17, wherein said communication bus comprises one of an unshielded cable or a shielded cable.
